(19) United States
(12) Patent Application Publication
(10) Pub. No.: US 2008/0317928 A1
(43) Pub. Date: Dec. 25, 2008

(54) Dairy Product and Process

(76) Inventor: Charles Towler, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 11/578,253

(22) PCT Filed: Apr. 14, 2004
(86) PCT No.: PCT/NZ04/00328

§ 371 Date: Dec. 10, 2007

(30) Foreign Application Priority Data
Apr. 14, 2004 (NZ) 532295

(51) Int. Cl. A23C 9/156; A23C 9/00

(52) U.S. Cl. 426/584; 426/580

(57) ABSTRACT

The invention provides a method of making a milk product, the method comprising: (a) combining a casein source, at least one sugar and glycerol monostearate (GMS), to form an intermediate product; and (b) lowering the pH of the intermediate product to below 4.6.

### FIELD OF THE INVENTION

The present invention relates to stable milk products having a pH below 4.6 and methods of making the same.

### BACKGROUND OF THE INVENTION

The most popular carbonated beverages typically have an acidity, or pH, of between 3.0 and 4.0 to give the consumer a pleasurable level of astringency. pH levels less than 3.0 in beverages are considered by many as being excessively astringent and not preferred. Carbon dioxide is added to the beverage to a pressure corresponding to at least 1.5 volumes gas per volume of beverage to give the consumer the required effervescence that is enjoyable in the mouth. These beverage products are widely known as carbonated beverages.

It is increasingly desirable to fortify carbonated beverages with protein to provide a drink with a more balanced nutrition. Milk protein is recognised widely as offering good nutrition.

Milk protein, particularly casein, added directly to the carbonated beverage, is unstable in the pH 3-4 range and tends to precipitate or sediment to the bottom of the vessel because the pH is close to the isoelectric point of the casein. Sediment is not appealing to the consumer and can result in the wastage of valuable protein. The stability of casein, and therefore milk protein, in a carbonated beverage depends on the interaction of many factors. The art does not offer much guidance of what will work and what will yield a carbonated beverage fortified with milk that will be enjoyed by consumers.

A feature of the large-scale manufacture of carbonated beverages is that plants are often run as franchised businesses that are not equipped with milk handling and processing facilities. The handling and processing of most milk or dairy streams would result in significant investment to a carbonated beverage bottler. The hygiene risk to a carbonated beverage bottler would be considerable because they are not generally experienced in handling stocks that are as perishable such as milk.

The art teaches various methods of attempting to overcome the problems of preparing successful carbonated beverages that contain various amounts of milk, or milk protein.

Ahmed in U.S. Pat. No. 4,804,552 and in U.S. Pat. No. 4,919,960 suggests that heating the milk or beverage prior to bottling and carbonation will result in a stable carbonated milk beverage. Pasteurisation is claimed to be sufficient. There is no teaching of the initial preparation of a stable concentrate. Ino et al. (U.S. Pat. No. 3,800,052) teaches a milk-sugar solution acidified to pH 3.5-3.7 and heated to 60° C. for 20 minutes that is stable. Yasumatsu (U.S. Pat. No. 4,194,019) teaches that a stable carbonated milk beverage may be prepared by treating an acidified milk+sugar syrup with an extensive heat treatment of 125-160° C. for a period depending on the selected temperature.

Another approach, reported to give stability to a carbonated milk beverage, is revealed by Efstathiou, Dechaine & Zoss (U.S. Pat. No. 4,676,988). In this process ion exchange is used to remove anions and cations from the milk.

Another method to stabilise carbonated milk beverages is to use a suitable hydrocolloid or polysaccharide such as pectin or carageenan (Rimmler & Sas, DE 19,735,385; Mahmoud, NL 7,809,568; Lam & Petitfour, EP 1,150,573; Kelly, GB2398473).

A further approach is to replace a proportion of the problematic casein with soluble proteins such as whey proteins (Scibelli, U.S. Pat. No. 4,200,662).

An alternative approach is to overcome sedimentation of insoluble material by dispersing the particles sufficiently finely that they resist settling (Yang, U.S. Pat. No. 5,648,112).

Another process is to ferment the milk to produce a drinking yoghurt which can be combined with juices or fruit pulp and subsequently carbonated (Meiji Milk Products, JP 1,022,861; Hao, CN 1,061,512; Evers, EP0117011).

Clark & Clark teach of a carbonated milk beverage fortified with various nutrients (U.S. Pat. No. 6,403,129). However, this is a near neutral product that does not encounter the problems faced by the acidity typical of carbonated beverages even though a pH range of about 4.0 to about 7.0 is claimed. This process also teaches of preparing a dried mixture of the ingredients, which may be subsequently reconstituted with water, carbonated and packed. It does not teach of a means of preparing a stable liquid concentrate suitable for storage and shipment and does not teach how to obtain a good flavoured carbonated beverage in the desired pH range 3.0-4.0.

In applications US 200201 14872 and US 20020182296 Kaplan claims a process to prepare a UHT treated carbonated milk beverage. A pH range between 3.8 and 5.7 is claimed although no measures to deal with protein instability are acknowledged.

In GB1480902, it is noted that a carbonated beverage containing as little as 4-12% w/w milk (0.12-0.4% protein) yields a ‘stable frothy head’.

Accordingly, it is an object of the present invention to produce a stable milk product containing a casein source at a pH range below the isoelectric point of casein and/or to provide the public with a useful choice.

### DISCLOSURE OF THE INVENTION

In a first aspect, the invention comprises a method of making a milk product, the method comprising:
(a) combining a casein source, at least one sugar and glycerol monostearate (GMS), to form an intermediate product; and
(b) lowering the pH of the intermediate product to below 4.6.

Preferably the milk product contains between 0.1% w/w and 10% w/w casein, more preferably between 0.2% w/w and 5% w/w casein.

The milk product may be a milk protein-containing beverage. Alternatively the milk product is a beverage ingredient, for example a concentrate or a syrup. The beverage ingredient may be subsequently used to prepare a milk protein-containing beverage.

Preferably the sugar is selected from at least one of sucrose, fructose, corn syrup, invert syrup and glucose.

Preferably, the GMS is added to the casein source after the sugar has been added to the milk. The preferred level of addition of the glycerol monostearate to the casein source is up to 0.5% w/w, more preferably from 0.01% w/w to 0.5% w/w, most preferably 0.1% w/w to 0.5% w/w. The preferred level of addition of the sugar to the casein source is from 0.5:1 sugar:casein to 25:1 sugar to casein, more preferably 1:1 sugar:casein to 20:1 sugar to casein, most preferably 2:1 sugar:casein to 15:1 sugar to casein.

Alternatively, the GMS may be added to the casein source before the addition of sugar. Alternatively the GMS and sugar are added to the casein source at the same time.

Preferably the casein source is selected from at least one of whole milk, skim milk, skim milk concentrate, skim milk powder, skim milk retentate, concentrated milk, buttermilk, ultrafiltered milk retentate, calcium depleted milk protein concentrate, calcium depleted milk protein concentrate, low fat milk, and low fat milk protein concentrate. Preferably the fat level in the casein source is less than 10% of the amount of casein in the casein source, preferably less than 5%, most preferably less than 1%. The dried versions of the casein source may be reconstituted with a potable solvent before use in accordance with the methods of the present invention.

The intermediate product is a mixture of a casein source, a sugar and GMS that is preferably in a concentrated form. More preferably, the intermediate product is a liquid that is ambient temperature stable against microbiological deterioration for a period of at least one month.

Preferably the pH of the intermediate product is lowered to between a pH of 3.0 and 4.0. Preferably the pH is lowered to between 3.0 and 3.8. Preferably the pH is lowered to between 3.0 and 3.7.

Preferably the pH of the intermediate product is lowered by the addition of an acid. Preferably the acid is a polyvalent acid. Preferred polyvalent acids for use in the present invention may be selected from citric acid, phosphoric acid, malic acid and tartaric acid. Most preferably the polyvalent acid is selected from citric acid, phosphoric acid and a combination thereof.

In a further aspect of the invention, the milk product is subsequently carbonated. Carbonation includes any food grade gas capable of producing effervescence in a beverage.

Preferably the carbonation level is between 0.1 volume CO₂/volume beverage and 5 volume CO₂/volume beverage.

Preferably the carbonated milk beverage includes optional ingredients such as water, juice, flavour, sweetener, colorant, preservative and gas.

In another aspect the present invention provides a milk product produced by a method of the present invention.

In a further aspect the present invention provides a milk product having a pH below 4.6, comprising a casein source, at least one sugar and GMS.

### PREFERRED EMBODIMENT

A milk stream, containing about 5% protein and less than about 0.5% fat is warmed to about 50° C. to reduce the viscosity and sugar is added. The sugar may be substantially sucrose, or fructose or glucose or a mixture and may be in the form of a syrup or a mixture of syrup and crystals. Sugar is added to obtain a concentrated solution that has a solids content of at least 40%, preferably at least 50% and more preferably at least 55% w/w. While the solution is hot, GMS is added and dispersed in the intermediate product. The quantity of GMS added is about 0.4% w/w of the intermediate product.

The intermediate milk is cooled to less than about 20° C. and acid added with stirring. Preferably the acid is phosphoric acid diluted about 1:1 w/w with water. The pH of the milk product is about 3.1. The milk product is held in a suitable storage vessel where it can be stored and transported at ambient temperature with microbiological stability. Preferred vessels are stainless steel or plastic.

The milk product may be drained from the vessel when desired, water, carbonated water, flavouring, colorant, stabilizer or preservative (such as potassium sorbate and/or sodium benzoate) added as required, and once fully mixed and temperature adjusted, transferred to a bottling plant. Further carbon dioxide or food grade gas capable of producing effervescence may be added during the bottle filling process to provide a carbonated milk beverage. The beverage contains preferably about 2 volumes of gas per volume of beverage with a pH of about 3.7. The levels of gas added to the water or beverage streams and at the filling head of the bottler and the temperatures of the streams can be adjusted to convenient values according to values known in the art of carbonated beverage preparation.

Once the bottles are filled, they may be capped, packed and made available for distribution via normal beverage supply chains.

### BRIEF DESCRIPTION OF THE DRAWING

A preferred embodiment of the present invention will now be described with reference to the figures of the accompanying drawings in which:

FIG. 1 shows a schematic diagram of the process of a preferred embodiment of the invention.

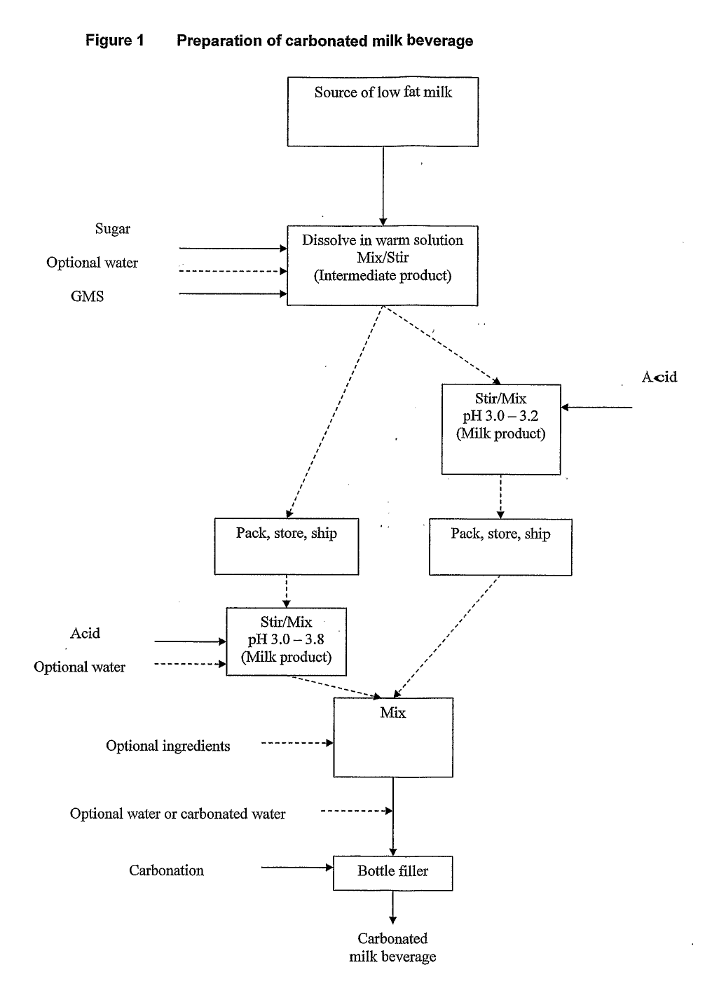

### EXAMPLES

The following Examples further illustrate practice of the invention.

### GMS Aids Syrup Stability and Controls Foam

Sweetened condensed milk (consisting of a solution of milk and sugar, containing about 60% solids), is a product long known for its stability and keeping quality at ambient temperature where the tinned product may be kept by the consumer for years without deterioration. Sweetened condensed milk may be useful to a CSD bottler as a syrup concentrate where the acid, flavouring, carbonated water and other ingredients are added prior to, or during the bottling process. However, we have found that sugar fortified milk concentrate tends to foam in contact with carbonated water. Although this concentrate may be used as a pre-prepared concentrate by a bottler, it may not be preferred unless foaming can be controlled. The risk of spoilage would be further reduced if the concentrated syrup was able to be pre-acidified. It would also be more convenient to the bottler because one less ingredient would simplify the final beverage formulation at the bottling plant. An experiment was conducted to investigate acid stability and foaming tendency. Concentrates according to the recipes in Table 1 were prepared.

TABLE 1
Formulation of syrup concentrates

| Quantity (g) | Control | With additive (1) | With additive (2) |
|---|---|---|---|
| Skim Milk Powder | 229 | 229 | 229 |
| Sucrose | 550 | 550 | 550 |
| Water | 550 | 550 | 550 |
| Additive GMS | 0 | 1.0 | 5.0 |

The skim milk powder (low heat SSMP, Fonterra Co-operative Group Ltd, Auckland) and sucrose (Chelsea 1A sugar, New Zealand Sugar Co., Auckland) were blended together and dispersed in hot tap water. After hydrating for at least 20 min., the mixtures were heated to 75° C. and mixed with an Ultra-turrax high shear mixer while the GMS (Admul MG 42-04K glycerol monostearate [Quest Ltd.]) was added. Once fully blended, the syrups were cooled to 10° C. and with continued mixing using a Heidolph RZR1 stirrer (Heidolph, Kehleim, Germany) approximately 25 mL of 50% phosphoric acid was added to give a pH of 3.2. The following day, 610 g of each syrup were taken and made up to 5000 g with 5° C. (saturated) carbonated water (supplied from a Lancer Turbo-carb carbonator, Lancer, San Antonio, Tex.) and bottled. Mixing the carbonated water with syrups Control and Additive (1) resulted in excessive foaming and these syrups were considered unacceptable. Surprisingly the addition of the carbonated water to the syrup Additive (2) resulted in significantly less foam and was considered acceptable.

The syrups were stored at ambient temperature for approximately three to four months whereupon their stability and quality were observed. The results are shown in Table 2.

TABLE 2
Characteristics of syrup concentrates

| | Control | With additive (1) | With additive (2) |
|---|---|---|---|
| Total solids % | 58.6 | 58.7 | 58.8 |
| Condition after 3 | Unstable with | Unstable with | Stable |
| months storage | phase | phase separation | |
| | separation | | |
| Foam on contact | Excessive | Considerable | Acceptable |
| with carbonated | | | |
| water | | | |

Surprisingly, the addition of GMS (0.4%) prior to the addition of the acid had a beneficial effect on both the acid stability of the syrup concentrate and the propensity of the solution to foam.

### MPC Reduces Acid Requirement and Improves Flavour

Acidity (as measured quantitatively by pH) does not entirely define the taste sensation as described by the attribute of acid/astringent. Accordingly, it was desired to attain the target pH of the beverage (3.6) whilst increasing the consumer appeal by reducing the astringency of the beverage. A range of beverages with the same protein concentration (0.7%) was prepared using the recipes shown in Table 3. ALAPRO® milk protein concentrates (MPCs) were obtained from Fonterra Co-operative Group Limited, Auckland.

TABLE 3
Formulation of beverages

| | Beverage 1 | Beverage | Beverage | |
|---|---|---|---|---|
| Ingredients (g) | (Control) | 2 | 3 | Beverage 4 |
| Skim Milk | 900 | | | |
| Powder (SMP) | | | | |
| ALAPRO ® 4560 | | 550 | | |
| ALAPRO ® 4700 | | | 440 | |
| ALAPRO ® 4850 | | | | 362 |
| Sucrose | 4400 | 4400 | 4400 | 4400 |
| GMS | 22 | 22 | 22 | 22 |
| Water | 2698 | 2698 | 2698 | 2698 |
| 50% phosphoric | 134 | 106 | 96 | 84 |
| acid (mL) | | | | |
| Potassium | N.A. | 8.8 | 8.8 | 8.8 |
| sorbate | | | | |
| Sodium | N.A. | 8.8 | 8.8 | 8.8 |
| benzoate | | | | |

A syrup concentrate was initially prepared by dissolving the dry ingredients in hot tap water. After hydrating the mixes were heated to 75° C. and mixed with the Ultra-turrax high shear mixer. The mixtures were cooled to approximately 20° C. and the phosphoric acid added a Heidolph stirrer. The syrups were held in a fridge overnight at about 5° C. The next day, the syrups were diluted with water to 40 kg and bottled into PET bottles using an Armfield FT102-A Carbo-fill carbonator (Armfield Ltd., Ringwood, Hampshire, England) at a filling temperature of 14.5° C. and a CO₂ pressure of 1.5 Bar. This gave beverages with approximately 0.7% milk protein with approximately 2.5 volumes carbon dioxide. The pH values of the recipes are shown in Table 4.

TABLE 4
Acidity (pH) of syrup concentrates and beverages

| | Beverage 1 | | | |
|---|---|---|---|---|
| | (Control) | Beverage 2 | Beverage 3 | Beverage 4 |
| pH syrup | 3.1 | 3.2 | 3.2 | 3.2 |
| pH beverage | 3.6 | 3.6 | 3.65 | 3.6 |

Surprisingly despite having the same protein concentrations, the quantity of acid in the beverages required to attain the desired pH (about 3.6) was considerably reduced with the use of high protein MPC as the source of milk protein. This discovery enhanced the consumer appeal of the beverage concept for the preparation of milk protein fortified CSDs.

The bottles of beverage were stored at ambient temperature for seven months, whereupon they were tasted. All were free of off flavours and were acceptable as an unflavoured base for CSD beverages. The SMP beverage was described as “tangy” with the higher protein MPC stocks less astringent and described as very pleasant CSD base beverages. High temperature treatments were not required to attain a stable beverage.

The microbiological quality of the beverages was tested upon bottling and after seven months of storage. The results are shown in Table 5.

TABLE 5
Microbiological stability of beverages

| | Beverage 1 (Skim | Beverage 2 | Beverage 4 |
|---|---|---|---|
| | milk powder) | (MPC56) | (MPC85) |
| | Freshly bottled | | |
| Coliforms | <1 | <1 | <1 |
| Aerobic Plate Count | 170-970 | 1600-3200 | <1 |
| Yeasts & Moulds | <1 | 120-340 | <1 |
| | After 7 months ambient storage | | |
| Coliforms | <1 | <1 | <1 |
| Aerobic Plate Count | 7 | <1 | 7 |
| Yeasts & Moulds | <1 | <1 | <1 |

The microbiological condition of the samples was good and counts tended to decline with storage time. High temperature treatments were not required to obtain a stable microbiological condition in the bottled beverage.

### Mineral Modified MPC Beverage

A mineral modified MPC (calcium replaced with sodium) [ALAPRO® 4861] was compared with the corresponding standard MPC (both approximately 85% protein). Syrups and carbonated beverages were prepared according to the above procedure for ALAPRO® MPC85. After five months storage at ambient temperature the beverage samples were examined and sampled. The standard MPC85 had a slight but acceptable sediment compared with the MPC 4861 beverage which had negligible sediment. Both had a pleasant and very acceptable flavour.

The above Examples are illustrations of practice of the invention. It will be appreciated by those skilled in the art that the invention can be carried out with numerous modifications and variations. For example, a different casein source or sugar may be used. Similarly, among the many variations, different concentrations and pH values may be used.

1. A method of making a milk product, the method comprising:
(a) combining a casein source, at least one sugar and glycerol monostearate (GMS), to form an intermediate product; and
(b) lowering the pH of the intermediate product to below 4.6.

2. The method of claim 1 wherein the casein source is selected from at least one of whole milk, skim milk, skim milk concentrate, skim milk powder, skim milk retentate, concentrated milk, buttermilk, ultrafiltered milk retentate, calcium depleted milk protein concentrate, calcium depleted milk protein concentrate, low fat milk, and low fat milk protein concentrate.

3. The method of claim 1 wherein the fat level in the casein source is less than 10% of the amount of casein in the casein source.

4. The method of claim 1 wherein the fat level in the casein source is less than 5% of the amount of casein in the casein source.

5. The method of claim 1 wherein the fat level in the casein source is less than 1% of the amount of casein in the casein source.

6. The method of claim 1 wherein the sugar is selected from at least one of sucrose, fructose, corn syrup, invert syrup and glucose.

7. The method of claim 1 wherein the GMS is added to the casein source after the sugar has been added to the milk.

8. The method of claim 1 wherein the GMS is added to the casein source before the sugar has been added to the milk.

9. The method of claim 1 wherein the GMS and sugar are added to the casein source at the same time.

10. The method of claim 1 wherein the level of addition of the glycerol monostearate to the casein source is up to 0.5% w/w.

11. The method of claim 1 wherein the level of addition of the glycerol monostearate to the casein source is from 0.01% w/w to 0.5% w/w.

12. The method of claim 1 wherein the level of addition of the glycerol monostearate to the casein source is from 0.1% to 0.5% w/w.

13. The method of claim 1 wherein the level of addition of the sugar to the casein source is from 0.5:1 sugar:casein to 25:1 sugar to casein.

14. The method of claim 1 wherein the level of addition of the sugar to the casein source is from 1:1 sugar to casein to 20:1 sugar:casein.

15. The method of claim 1 wherein the level of addition of the sugar to the casein source is from 2:1 sugar:casein to 15:1 sugar to casein.

16. The method of claim 1 wherein the pH of the intermediate product is lowered to between a pH of 3.0 and 4.0.

17. The method of claim 1 wherein the pH of the intermediate product is lowered to between a pH of 3.0 and 3.8.

18. The method of claim 1 wherein the pH of the intermediate product is lowered to between a pH of 3.0 and 3.7.

19. The method of claim 1 wherein the pH of the intermediate product is lowered by the addition of an acid.

20. The method of claim 19 wherein the acid is a polyvalent acid.

21. The method of claim 20 wherein the polyvalent acid is selected from citric acid, phosphoric acid, malic acid and tartaric acid.

22. The method of claim 21 wherein the polyvalent acid is selected from citric acid, phosphoric acid and a combination thereof.

23. The method of claim 1 wherein the milk product is subsequently carbonated.

24. The method of claim 23 wherein the carbonation level is between 0.1 volume CO₂/volume beverage and 5 volume CO₂/volume beverage.

25. The method of claim 23 wherein the carbonated milk beverage includes one or more optional ingredients selected from water, juice, flavour, sweetener, colorant, preservative and gas.

26. The method of claim 1 wherein the milk product contains between 0.1% w/w and 10% w/w casein.

27. The method of claim 1 wherein the milk product contains between 0.2% w/w and 5% w/w casein.

28.-30. (canceled)

31. (canceled)

32. The method of claim 2 wherein the fat level in the casein source is less than 10% of the amount of casein in the casein source.
